(19) United States
(12) Patent Application Publication
(10) Pub. No.: US 2013/0238867 A1
(43) Pub. Date: Sep. 12, 2013

(54) METHOD AND APPARATUS TO DEPLOY AND BACKUP VOLUMES

(71) Applicant: Shinichi HAYASHI, San Jose, CA (US)

(72) Inventor: Shinichi HAYASHI, San Jose, CA (US)

(73) Assignee: HITACHI, LTD., Tokyo (JP)

(21) Appl. No.: 13/412,891

(22) Filed: Mar. 6, 2012

(51) Int. Cl. G06F 12/02; G06F 12/16

(52) U.S. Cl. 711/162; 711/E12.002; 711/E12.103

(57) ABSTRACT

A storage system comprises storage devices providing logical volumes. The storage devices are divided into a plurality of types of tiers having different performance levels. A controller is operable to control to store data to a logical volume of the logical volumes. The controller is configured to receive a command commanding to copy data to deploy a template to a logical volume of the logical volumes or to back up data to a logical volume of the logical volumes. In response to the command, the controller is configured to allocate a storage area of a tier of the plurality of types of tiers to the logical volume. The tier of the storage area to allocate to the logical volume is determined based on whether the command received by the controller is to copy data to the template to the logical volume or to back up data to the logical volume.

### BACKGROUND OF THE INVENTION

The present invention relates generally to tier management and, more particularly, to a method and an apparatus of tier management to deploy and backup volumes.

In recent years, thin provisioning has become popular. Thin provisioning is a method for allocating area for a storage system that receives a write command to an unallocated area and allocates physical devices in response to the write commands. Storage systems may also reallocate frequently accessed allocated area to fast and expensive media and rarely accessed allocated area to slow and cheap media. Generally, when storage systems receive a write command to an unallocated area, the storage systems allocates default tier area to the unallocated area.

According to one storage management method, a management server sends a volume copy command and a storage subsystem copies a volume to deploy or backup a volume (see FIG. 2). There is no negative effect to an application server because not the application server but the storage subsystem copies the volume. Copied data for deploy or backup is located on the default tier. Generally, the default tier is tier 1 or tier 2. If the copied data is for backup, there is no access to the copied data and the copied data is moved to tier 3. There are two problems. The first problem arises when active data cannot be located on tier 1 and tier 2 because a lot of copied data for backup is located on tier 1 or tier 2. The active data should be located on tier 1 or tier 2 and the backup data should be located on tier 3. The second problem arises when the backup data is moved to tier 3 because it creates a negative effect to the storage subsystem which moves the backup data to tier 3.

According to US2011/0202705, an administrator can locate a specified volume to a specified tier. However, the storage subsystem does not know whether a volume copy command from the management server is for deploy or backup. Therefore, the storage subsystem cannot locate the volume to an applicable or appropriate tier.

### BRIEF SUMMARY OF THE INVENTION

Exemplary embodiments of the invention provide a system in which a storage subsystem determines volume tier policy based on the purpose of a volume copy command. If the purpose is to deploy, the storage subsystem allocates an applicable tier based on the number of access to pages of the volume. If the purpose is to backup, the storage subsystem allocates tier 3 to pages of the volume (see FIG. 1). In this way, active data can be located on tier 1 and tier 2 and there is no negative effect to the storage.

In one embodiment, a management server appends the purpose of copy to the volume copy command. In another embodiment, the storage subsystem determines the purpose of copy based on information about template volumes. The storage subsystem acquires the information about the template volumes from the management server or an administrator inputs the information about the template volumes.

In accordance with an aspect of the present invention, a storage system comprises: a plurality of storage devices providing a plurality of logical volumes, the plurality of storage devices being divided into a plurality of types of tiers having different performance levels; and a controller operable to control to store data to a logical volume of the plurality of logical volumes provided by the storage devices. The controller is configured to receive a command commanding to copy data to deploy a template to a logical volume of the plurality of logical volumes or to back up data to a logical volume of the plurality of logical volumes. In response to the command received by the controller, the controller is configured to allocate a storage area of a tier of the plurality of types of tiers to the logical volume. The tier of the storage area to allocate to the logical volume is determined based on whether the command received by the controller is to copy data to the template to the logical volume or to back up data to the logical volume.

In some embodiments, the tier of the storage area to allocate to the logical volume for copying data to deploy the template to the logical volume is a higher performance tier than the tier of the storage area to allocate to the logical volume for backing up data to the logical volume. The tier of the storage area to allocate to the logical volume for backing up data to the logical volume is a lowest tier of all the tiers. The tier of the storage area to allocate to the logical volume for copying data to deploy the template to the logical volume is determined based on a number of access to pages of the logical volume, the tier for a larger number of access being a same performance tier as or a higher performance tier than the tier for a lower number of access. The command includes information specifying whether the command is to copy data to the template to the logical volume or to back up data to the logical volume.

In specific embodiments, the command includes information on a source storage volume from which to copy data to the logical volume and includes no information specifying whether the command is to copy data to the template to the logical volume or to back up data to the logical volume. The controller is configured to obtain template information specifying a storage device and a storage volume in the storage device for storing the template. If the source storage volume is same as the storage volume for storing the template, then the command is to copy data to the template. The template information is obtained from a management computer or from a template volume input by an administrator. The template is a virtual machine template.

Another aspect of the invention is directed to a method of storing data to a logical volume of a plurality of logical volumes provided by a plurality of storage devices which are divided into a plurality of types of tiers having different performance levels in a storage system, in response to a command received by a controller of the storage system, commanding to copy data to a template to a logical volume of the plurality of logical volumes or to back up data to a logical volume of the plurality of logical volumes. The method comprises: determining, by the controller, a tier of a storage area to allocate to the logical volume based on whether the command is to copy data to the template to the logical volume or to back up data to the logical volume; and allocating to the logical volume, by the controller, the storage area of the determined tier of the plurality of types of tiers.

Another aspect of this invention is directed to a computer-readable storage medium storing a plurality of instructions for controlling a data processor to store data to a logical volume of a plurality of logical volumes provided by a plurality of storage devices which are divided into a plurality of types of tiers having different performance levels in a storage system, in response to a command received by a controller of the storage system, commanding to copy data to a template to a logical volume of the plurality of logical volumes or to back up data to a logical volume of the plurality of logical volumes. The plurality of instructions comprise: instructions that cause the data processor to determine a tier of a storage area to allocate to the logical volume based on whether the command is to copy data to the template to the logical volume or to back up data to the logical volume; and instructions that cause the data processor to allocate to the logical volume the storage area of the determined tier of the plurality of types of tiers.

These and other features and advantages of the present invention will become apparent to those of ordinary skill in the art in view of the following detailed description of the specific embodiments.

### BRIEF DESCRIPTION OF THE DRAWINGS

FIG. 1 is a hardware configuration of a system showing the allocation of tier 3 storage to backup data and the allocation of tier 1 and tire 2 to active data.

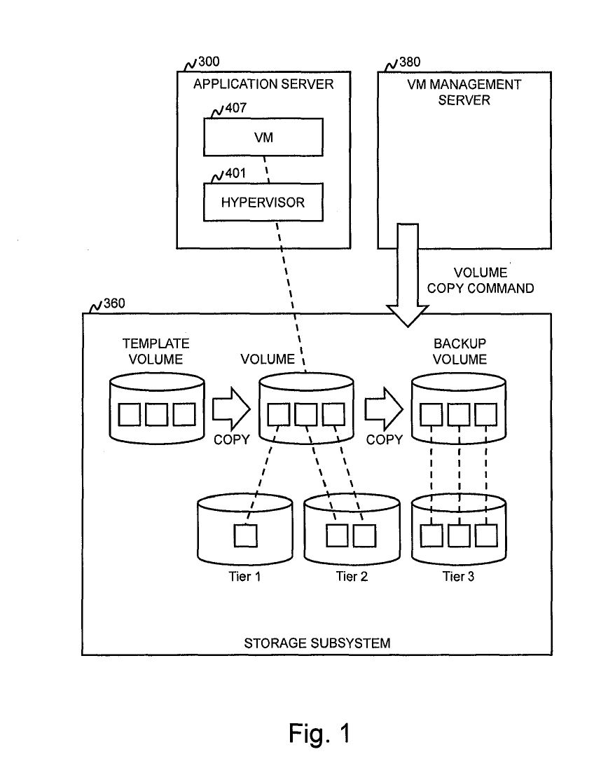

FIG. 2 is a hardware configuration of a system showing the allocation of tier 1 or tier 2 as the default tier 3 to copied data including active data and backup data, and the need to move backup data to tier 3 by the storage subsystem.

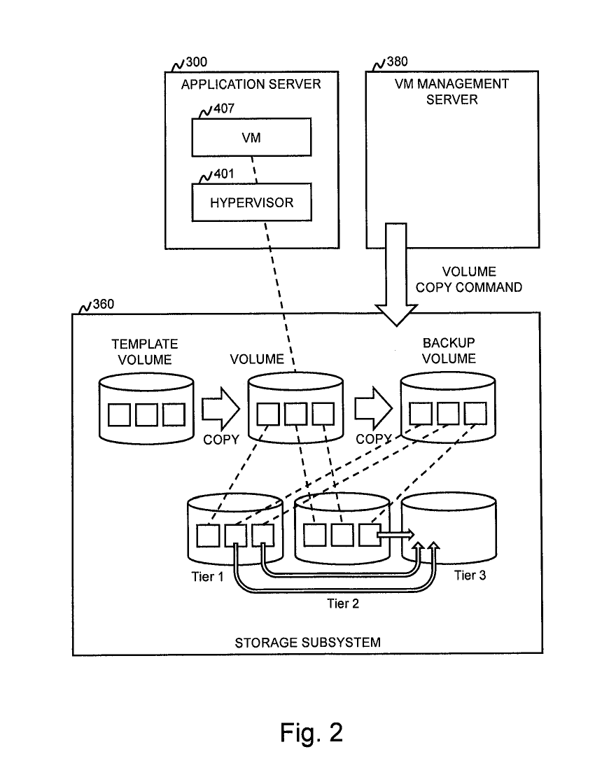

FIG. 3 illustrates an example of a hardware configuration of an information system in which the method and apparatus of the invention may be applied.

FIG. 4 illustrates an example of the memory in the application server of FIG. 3.

FIG. 5 illustrates an example of the memory in the storage subsystem of FIG. 3 according to the first embodiment of the invention.

FIG. 6 illustrates an example of the memory in the management server of FIG. 3.

FIG. 7 shows an example of the VHD location information.

FIG. 8 shows an example of the server information.

FIG. 9 shows an example of the VM information.

FIG. 10 shows an example of the RAID group information.

FIG. 11 shows an example of the logical volume information.

FIG. 12 shows an example of the storage pool information.

FIG. 13 shows an example of the virtual volume information.

FIG. 14 shows an example of the virtual volume tier policy information.

FIG. 15 shows an example of the tier definition information.

FIG. 16 shows an example of the VM template information.

FIG. 17 shows an example of the VM backup information.

FIG. 18 shows an example of the VM deploy screen.

FIG. 19 shows an example of the VM restore screen.

FIG. 20 shows an example of a VHD read command.

FIG. 21 shows an example of a VHD write command.

FIG. 22 shows an example of a read command.

FIG. 23 shows an example of a write command.

FIG. 24 shows an example of a VM deploy command.

FIG. 25 shows an example of a volume copy command according to the first embodiment.

FIG. 26 shows an example of a volume copy command reply.

FIG. 27 shows an example of a volume delete command.

FIG. 28 is an example of a flow diagram showing a process performed by the VHD control program.

FIG. 29 is an example of a flow diagram showing a process performed by the disk control program.

FIG. 30 is an example of a flow diagram showing the process by which the page move program moves pages.

FIG. 31 is an example of a flow diagram showing the process by which the VM deploy program deploys a VM.

FIG. 32 is an example of a flow diagram showing the process by which the VM backup program backs up a VM regularly every backup cycle.

FIG. 33 is an example of a flow diagram showing the process to be performed when the volume configuration program receives the volume copy command or the volume delete command according to the first embodiment.

FIG. 34 illustrates an example of the memory in the storage subsystem of FIG. 3 according to the second embodiment.

FIG. 35 shows an example of the template volume input screen according to the second embodiment.

FIG. 36 shows an example of a volume copy command according to the second embodiment.

FIG. 37 is an example of a flow diagram showing the process to be performed when the volume configuration program receives the volume copy command or the volume delete command according to the second embodiment.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment,” “this embodiment,” or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for tier management to deploy and backup volumes.

### First Embodiment

A. System Configuration

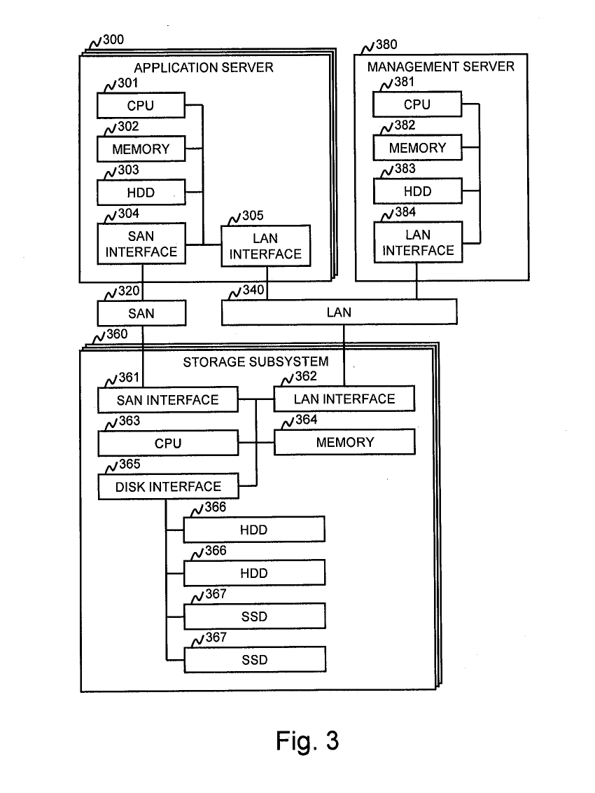

FIG. 3 illustrates an example of a hardware configuration of an information system in which the method and apparatus of the invention may be applied. The system comprises one or more application servers 300, a SAN (Storage Area Network) 320, a LAN (Local Area Network) 340, one or more storage subsystems 360, and a management server 380. The application server 300 comprises a CPU (Central Processing Unit) 301, a memory 302, a HDD (Hard Disk Drive) 303, a SAN interface 304, and a LAN interface 305. The CPU 301 reads programs from the memory 302 and executes the programs. The memory 302 reads programs and data from the HDD 303 when the application server 300 starts, and it stores the programs and the data. The HDD 303 stores programs and data. The SAN interface 304 connects the application server 300 and the SAN 320. The LAN interface 305 connects the application server 300 and the LAN 340. The SAN 320 connects the application server 300 and the storage subsystem 360. The application server 300 uses the SAN 320 to send application data to the storage subsystem 360 and receive application data from the storage subsystem 360. The application server 300, the storage subsystem 360, and the management server 380 use the LAN 340 to send management data and receive management data. The LAN 340 connects the application server 300, the storage subsystem 360, and the management server 380.

The storage subsystem 360 comprises a SAN interface 361, a LAN interface 362, a CPU 363, a memory 364, a disk interface 365, a HDD 366, and a SSD (Solid State Drive) 367. The SAN interface 361 connects the storage subsystem 360 and the SAN 320. The LAN interface 362 connects the storage subsystem 360 and the LAN 340. The CPU 363 reads programs from the memory 364 and executes the programs. The memory 364 reads programs and data from the HDD 366 and the SSD 367 when the storage subsystem 360 starts and stores the programs and the data. The disk interface 365 connects the storage subsystem 360, the HDD 366, and the SSD 367. The HDD 366 stores programs and data. The SSD 367 stores programs and data. The management server 380 comprises a CPU 381, a memory 382, a HDD 383, and a LAN interface 384. The CPU 381 reads programs from the memory 382 and executes the programs. The memory 382 reads programs and data from the HDD 383 when the management server 380 starts, and it stores the programs and the data. The HDD 383 stores programs and data. The LAN interface 384 connects the management server 380 and the LAN 340.

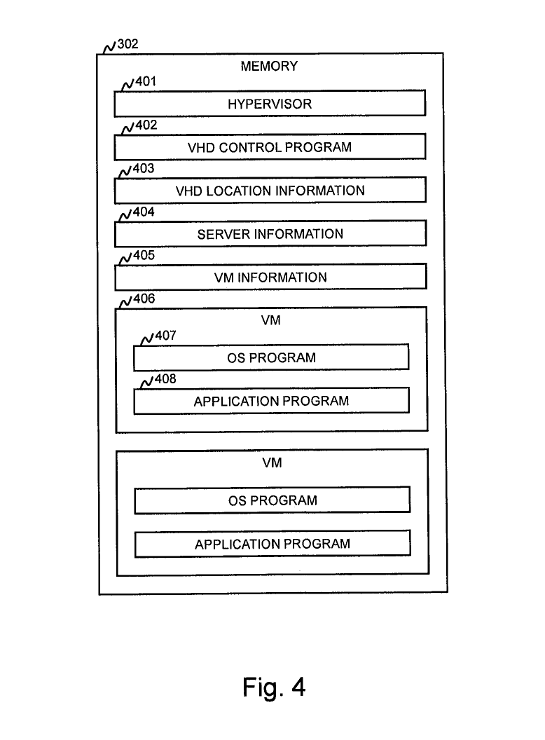

FIG. 4 illustrates an example of the memory 302 in the application server 300 of FIG. 3. The memory 302 comprises a hypervisor 401, VHD (Virtual Hard Disk) control program 402, VHD location information 403, server information 404, VM (Virtual Machine) information 405, a VM 406, an OS (Operating System) program 407, and an application program 408. The hypervisor runs the OS program 407 in the VM 406. The OS program 407 executes the application program 408. The application program 408 (e.g., database program) sends a VHD read command and a VHD write command to the VHD control program 402 to read data from the storage subsystem 360, process data, and write the results to the storage subsystem 360. VHD is a file format that provides a virtual hard disk drive to VM. The VHD control program 402 manages VHDs with the VHD location information 403. When the VHD control program 402 receives the VHD read command from the application program 408, the VHD control program 402 reads data from the storage subsystem 360 and sends the result to the application program 408. When the VHD control program 402 receives the VHD write command from the application program 408, the VHD control program 402 writes the data to the storage subsystem 360 and sends the result to the application program 408.

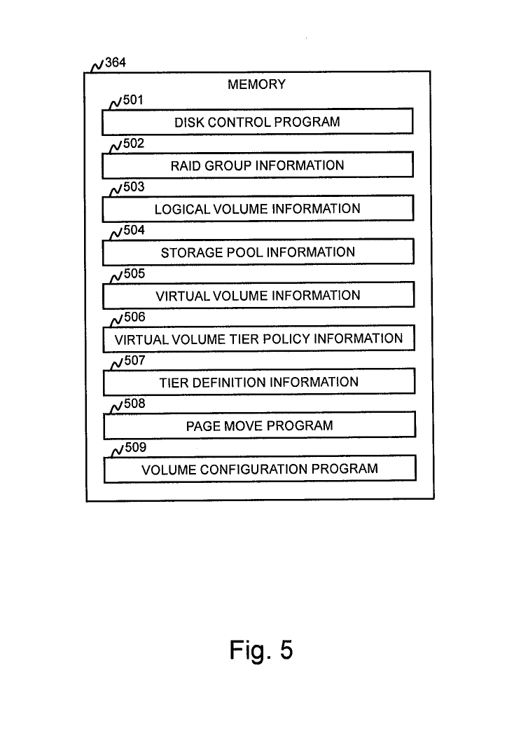

FIG. 5 illustrates an example of the memory 364 in the storage subsystem 360 of FIG. 3 according to the first embodiment of the invention. The memory 364 comprises a disk control program 501, RAID (Redundant Arrays of Inexpensive (or Independent) Disks) group information 502, logical volume information 503, storage pool information 504, virtual volume information 505, virtual volume tier policy information 506, tier definition information 507, a page move program 508, and a volume configuration program 509. The disk control program 501 receives a read command and a write command from the application server 300, reads data from the HDD 366 and the SSD 367, and writes data to the HDD 366 and the SSD 367 using the RAID group information 502, the logical volume information 503, the storage pool information 504, the virtual volume information 505, virtual volume tier policy information 506, and the tier definition information 507.

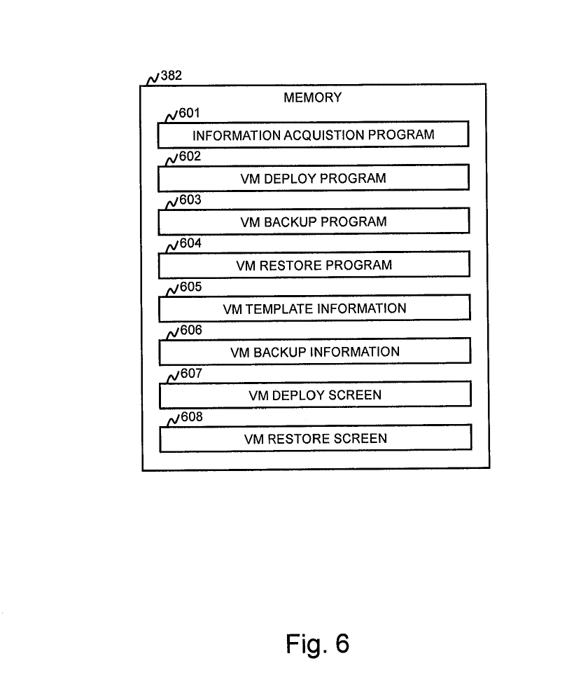

FIG. 6 illustrates an example of the memory 382 in the management server 380 of FIG. 3. The memory 382 comprises an information acquisition program 601, a VM deploy program 602, a VM backup program 603, a VM restore program 604, VM template information 605, VM backup information 606, a VM deploy screen 607, and a VM restore screen 608.

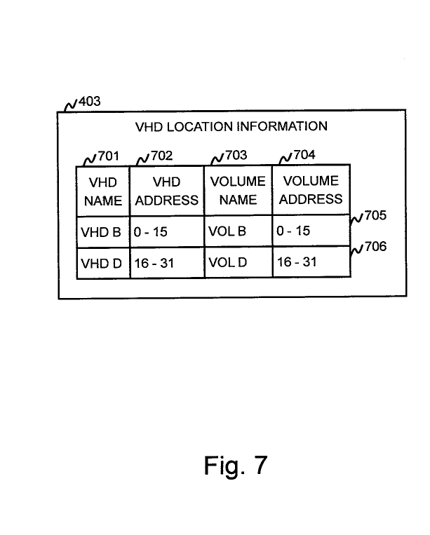

FIG. 7 shows an example of the VHD location information 403. The VHD location information 403 includes columns of a VHD name 701, a VHD address 702, a volume name 703, and a volume address 704. The VHD location information 403 shows data in an area specified by the VHD name 701 and the VHD address 702 is stored in an area specified by the volume name 703 and the volume address 704. FIG. 7 shows two sample entries 705, 706.

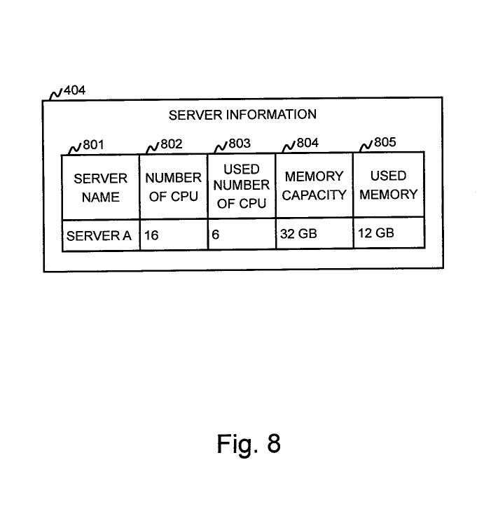

FIG. 8 shows an example of the server information 404. The server information 404 includes columns of a server name 801, a number of CPU 802, a used number of CPU 803, a memory capacity 804, and a used memory 805. The server information 404 shows the specification of the application server 300. The server name 801 shows the name of the application server 300. The number of CPU 802 shows the number of CPU that the application server 300 has. The used number of CPU 803 shows the number of CPU that is allocated to the VM 406. The memory capacity 804 shows the capacity that the application server 300 has. The used memory 805 shows the amount of memory that is allocated to the VM 406.

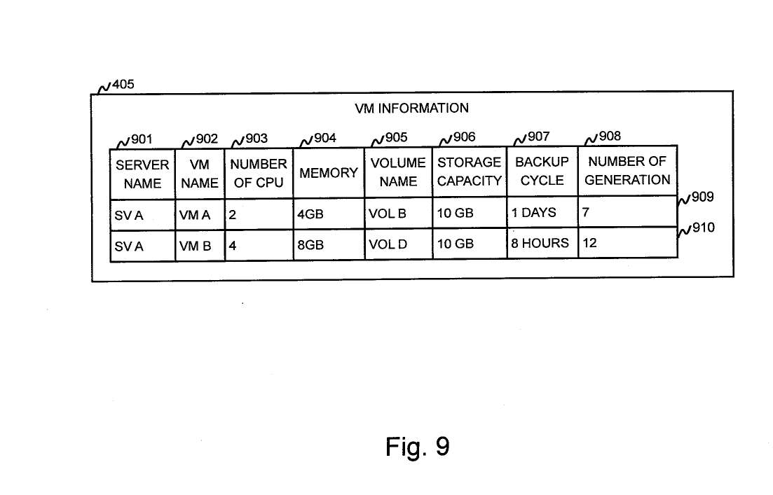

FIG. 9 shows an example of the VM information 405. The VM information 405 includes columns of a server name 901, a VM name 902, a number of CPU 903, a memory 904, a volume name 905, a storage capacity 906, a backup cycle 907, and a number of generation 908. The server name 901 shows that the VM 406 is running on. The VM name 902 shows the name of the VM 406. The number of CPU 903 shows the number of CPU that is allocated to the VM 406. The memory 904 shows the amount of memory that is allocated to the VM 406. The volume name 905 shows the volume name that is allocated to the VM 406. The storage capacity 906 shows the amount of storage that is allocated to the VM 406. The storage subsystem 360 copies a volume specified by the volume name 905 every cycle specified by the backup cycle 907 and retains the copied volumes of the number specified by the number of generation 908. FIG. 9 shows two sample entries 909, 910.

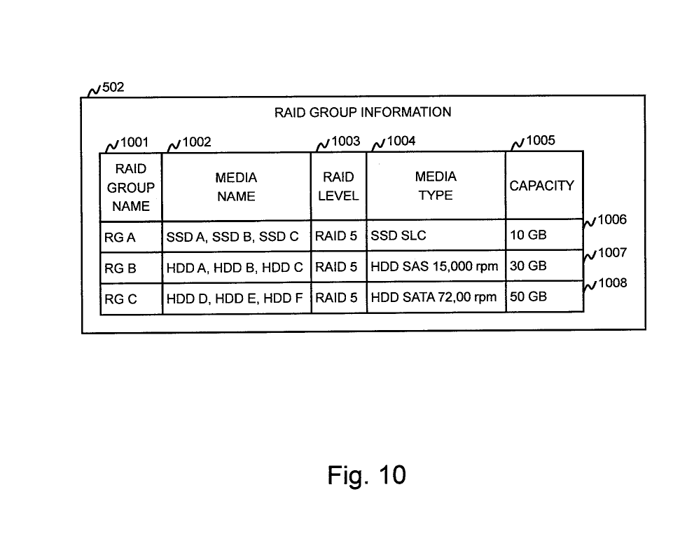

FIG. 10 shows an example of the RAID group information 502. The RAID group information 502 includes columns of a RAID group name 1001, a media name 1002, a RAID level 1003, a media type 1004, and a capacity 1005. The RAID group name 1001 shows the name of the RAID groups. The media name 1002 shows the media that comprise the RAID group specified by the RAID group name 1001. The RAID level 1003 shows the RAID level of the RAID group specified by the RAID group name 1001. The media type 1004 shows the media type of the RAID group specified by the RAID group name 1001. The capacity 1005 shows the capacity of the RAID group specified by the RAID group name 1001. FIG. 10 shows three sample entries 106, 1007, 1008.

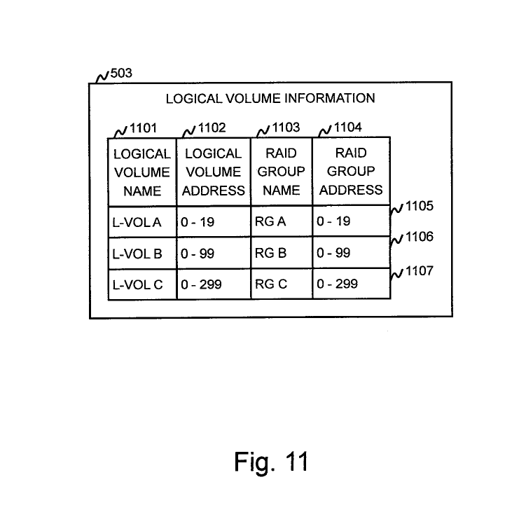

FIG. 11 shows an example of the logical volume information 503. The logical volume information 503 includes columns of a logical volume name 1101, a logical volume address 1102, a RAID group name 1103, and a RAID group address 1104. The area specified by the logical volume name 1101 and the logical volume address 1102 is mapped to the area specified by the RAID group name 1103 and the RAID group address 1104. FIG. 11 shows three sample entries 1105, 1106, 1107.

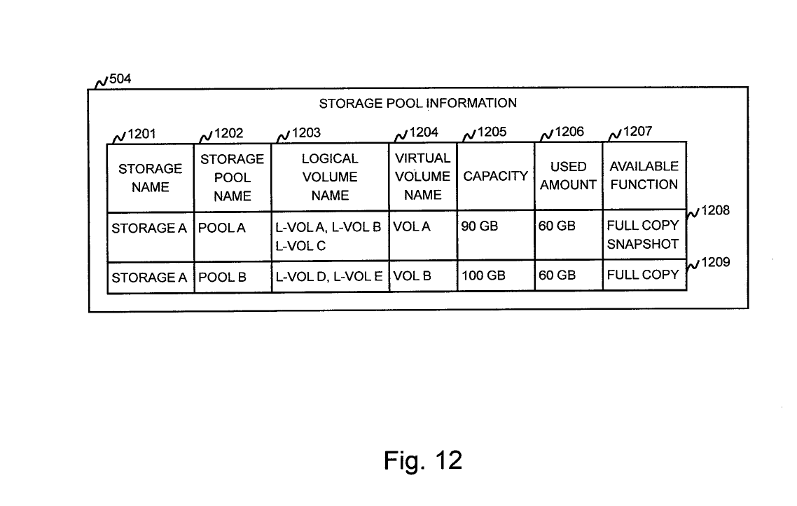

FIG. 12 shows an example of the storage pool information 504. The storage pool information 504 includes columns of a storage name 1201, a storage pool name 1202, a logical volume name 1203, a virtual volume name 1204, a capacity 1205, a used amount 1206, and an available function 1207. The storage pool information 504 shows that the storage pool name 1202 is located on the storage subsystem specified by the storage name 1201, comprises the logical volumes specified by the logical volume name 1203, and has the virtual volumes specified by the virtual volume name 1204. The capacity 1205 shows the capacity of the storage pool specified by the storage pool name 1202. The used amount 1206 shows the used amount of the storage pool specified by the storage pool name 1202. The available function 1207 shows the functions that the storage subsystem can apply to the storage pool specified by the storage pool name 1202. FIG. 12 shows two sample entries 1208, 1209.

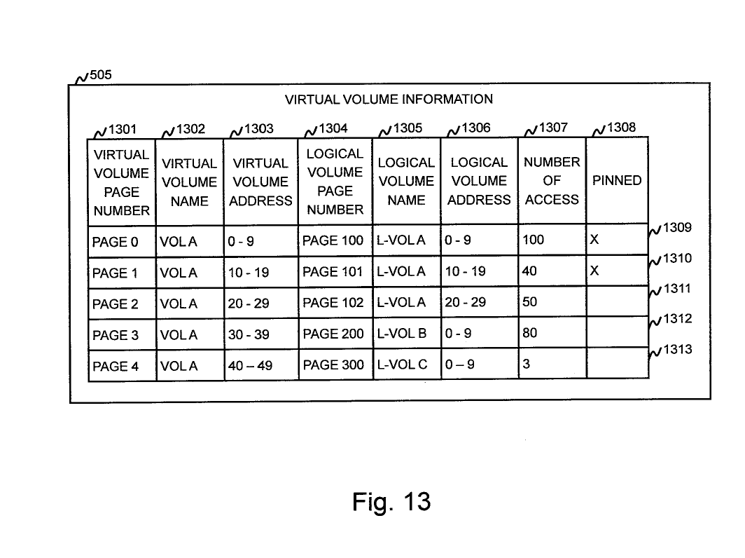

FIG. 13 shows an example of the virtual volume information 505. The virtual volume information 505 includes columns of a virtual volume page number 1301, a virtual volume name 1302, a virtual volume address 1303, a logical volume page number 1304, a logical volume name 1305, a logical volume address 1306, a number of access 1307, and pinned 1308. The virtual volume page number 1301 shows the page specified by the virtual volume name 1302 and the virtual volume address 1303. The logical volume page number 1304 shows the page specified by the logical volume name 1305 and the logical volume address 1306. The page specified by the virtual volume page number 1301 is mapped to the page specified by the logical volume page number 1304. The number of access 1307 shows the number of access to the page specified by the virtual volume page number 1301. The pinned 1308 shows the status whether the page specified by the virtual volume page number 1301 is pinned. If the pinned 1308 is “X”, the page specified by the virtual volume page number 1301 is pinned and the page move program 508 does not move the page to some other tier. FIG. 13 shows five sample entries 1309, 1310, 1311, 1312, 1313.

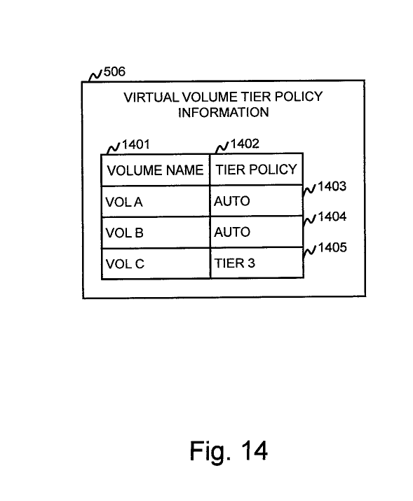

FIG. 14 shows an example of the virtual volume tier policy information 506. The virtual volume tier policy information 506 includes columns of a volume name 1401 and a tier policy 1402. The tier policy 1402 shows a policy of the volume specified by the volume name 1401. When the tier policy 1402 is “AUTO,” frequently accessed pages are moved to a higher tier and rarely accessed pages are moved to a lower tier. When the tier policy 1403 is not “AUTO,” pages are pinned to the tier specified by the tier policy 1402. FIG. 14 shows three sample entries 1403, 1404, 1405.

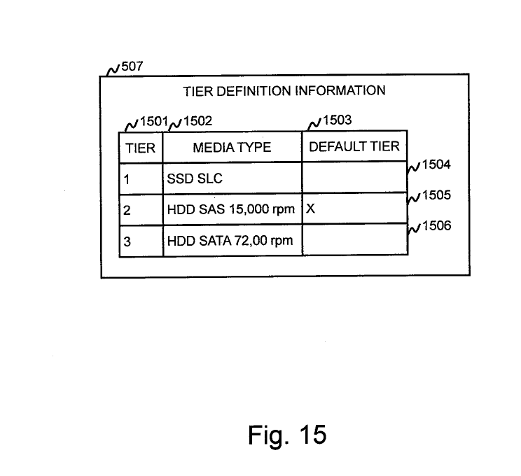

FIG. 15 shows an example of the tier definition information 507. The tier definition information 507 includes columns of a tier 1501, a media type 1502, and a default tier 1503. The media type 1502 shows the media of the tier specified by the tier 1501. If the default tier is “X”, the tier specified by the tier 1501 is allocated to unallocated area by the disk control program 501. FIG. 15 shows three sample entries 1504, 1505, 1506.

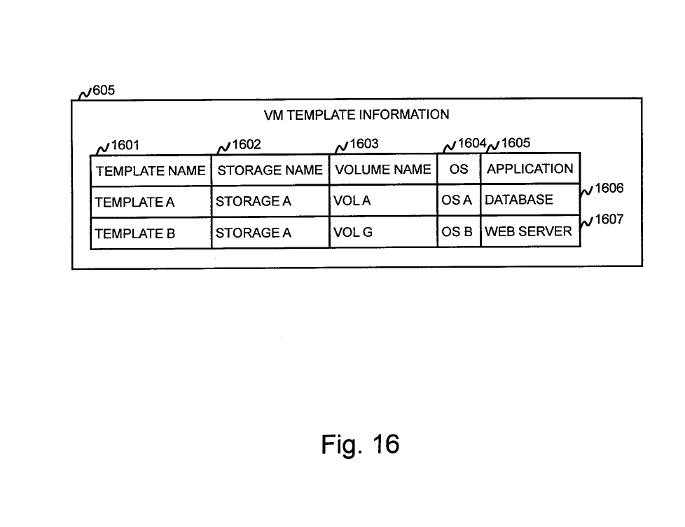

FIG. 16 shows an example of the VM template information 605. The VM template information 605 includes columns of a template name 1601, a storage name 1602, a volume name 1603, an OS 1604, and an application 1605. The VM template information 605 shows volumes in which VM templates are stored and OS and applications that are installed on the templates. FIG. 16 shows two sample entries 1606, 1607.

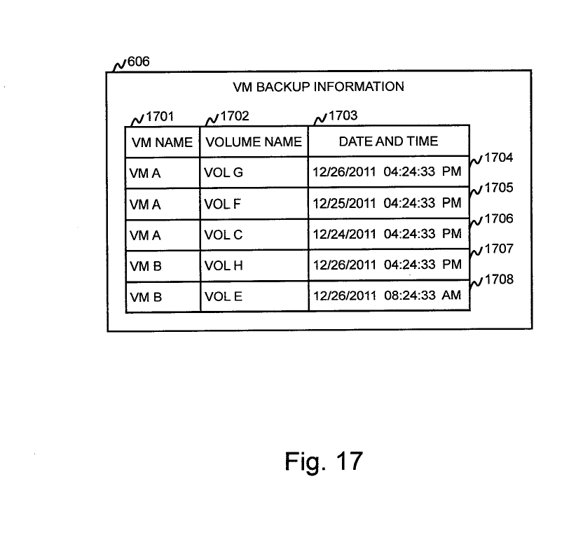

FIG. 17 shows an example of the VM backup information 606. The VM backup information 606 includes columns of a VM name 1701, a volume name 1702, and date and time 1703. The VM name 1701 shows the name that was backed up. The volume name 1702 shows the volume that stores the backup data. The data and time 1703 shows the date and time that the VM was backed up. FIG. 17 shows five sample entries 1704, 1705, 1706, 1707, 1708.

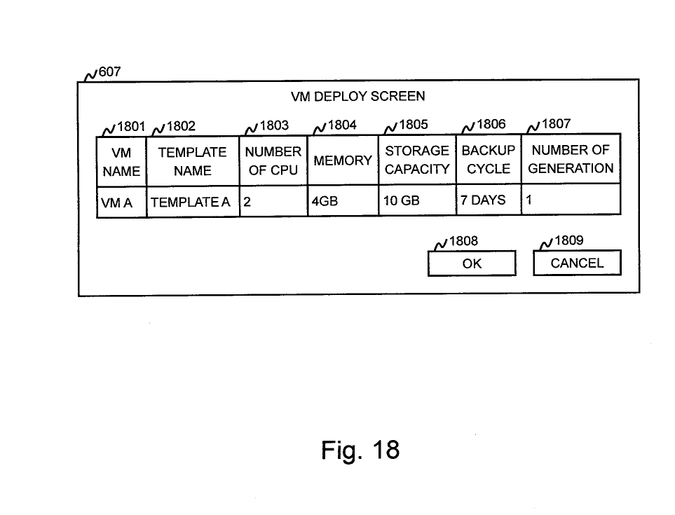

FIG. 18 shows an example of the VM deploy screen 607. The VM deploy screen 607 includes a VM name 1801, a template name 1802, a number of CPU 1803, a memory 1804, a storage capacity 1805, a backup cycle 1806, a number of generation 1807, an OK button 1808, and a cancel button 1809. An administrator inputs information of a VM to deploy to the management computer 380 with the VM deploy screen 607. The management computer 380 uses the information to deploy a VM. The VM name 1801 is the name of the VM to deploy. The template name 1802 is a VM template to copy to a VM to deploy. The number of CPU 1803 is the number of CPU of the VM to deploy. The memory 1804 is the capacity of memory of the VM to deploy. The storage capacity 1805 is the capacity of storage of the VM to deploy. The backup cycle 1806 is the backup cycle of the VM to deploy. The number of generation 1807 is the number of the volume of the VM to retain on the storage subsystem. When the administrator clicks the OK buttons 1808, the management server 380 deploys the VM based on the information on the VM deploy screen 607.

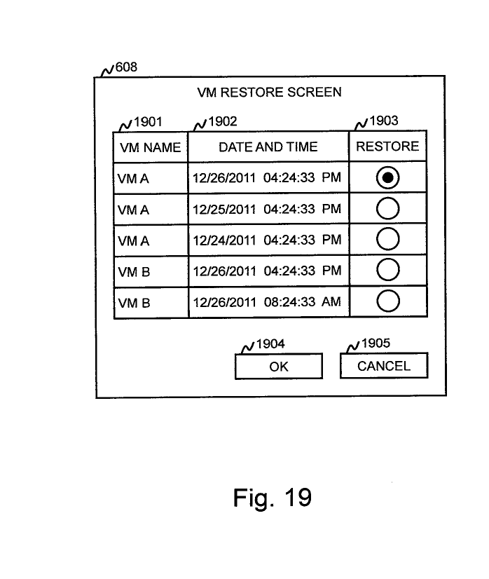

FIG. 19 shows an example of the VM restore screen 608. The VM restore screen 608 includes columns of a VM name 1901, date and time 1902, and a restore radio button 1903, and an OK button 1904 and a cancel button 1905. An administrator selects the VM that the administrator wants to restore based on the VM name 1901 and the date and time 1902, clicks the restore radio button 1903, and clicks the OK button 1904.

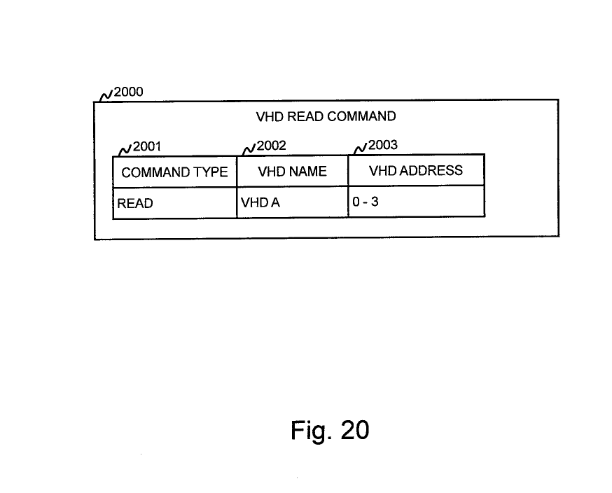

FIG. 20 shows an example of a VHD read command 2000. The VHD read command 2000 includes a command type 2001, a VHD name 2002, and a VHD address 2003. The application program 408 sends the VHD read command 2000 to the VHD control program 402 to read the area specified by the VHD name 2002 and the VHD address 2003.

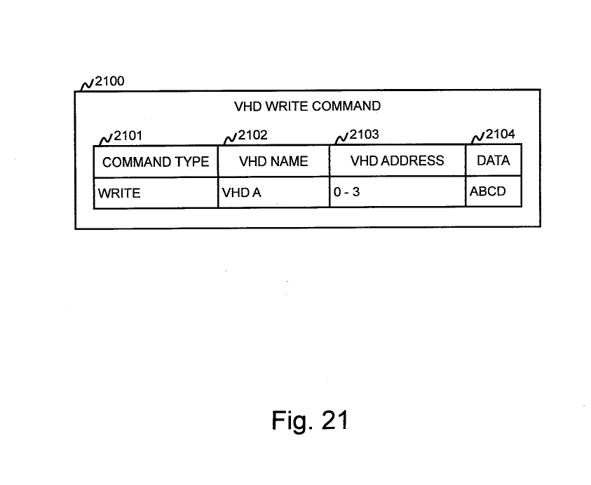

FIG. 21 shows an example of a VHD write command 2100. The VHD write command 2100 includes a command type 2101, a VHD name 2102, a VHD address 2103, and data 2104. The application program 408 sends the VHD write command 2100 to the VHD control program 402 to write the data specified by the data 2104 to the area specified by the VHD name 2102 and the VHD address 2103.

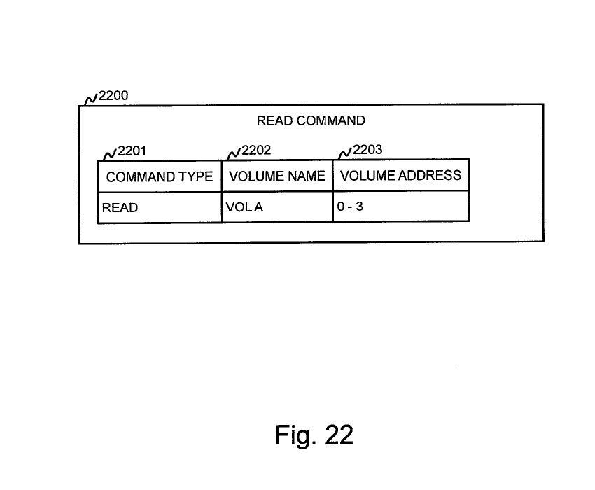

FIG. 22 shows an example of a read command 2200. The read command 2200 includes a command type 2201, a volume name 2202, and a volume address 2203. The VHD control program 402 sends the read command 2200 to the storage subsystem 360 to read the area specified by the volume name 2202 and the volume address 2203.

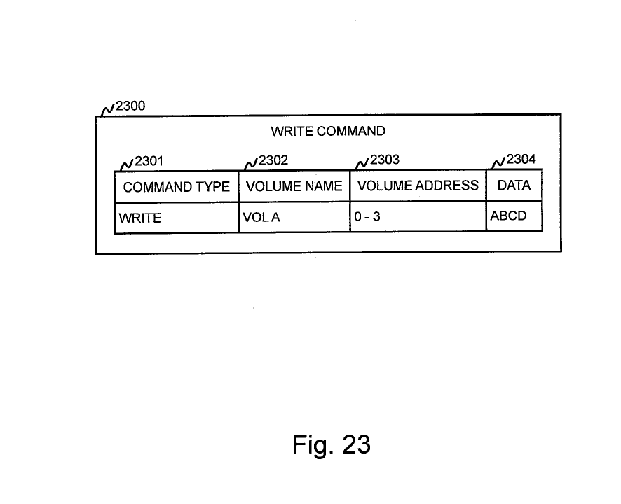

FIG. 23 shows an example of a write command 2300. The write command 2300 includes a command type 2301, a volume name 2302, a volume address 2303, and data 2304. The VHD control program 402 sends the write command 2300 to the storage subsystem 360 to write the data specified by the data 2304 to the area specified by the volume name 2302 and the volume address 2303.

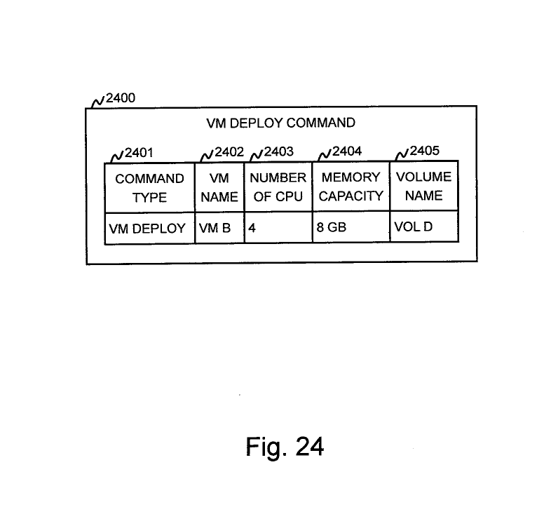

FIG. 24 shows an example of a VM deploy command 2400. The VM deploy command 2400 includes a command type 2401, a VM name 2402, a number of CPU 2403, a memory capacity 2404, and a volume name 2405. The management server 380 sends the VM deploy command 2400 to the application server 300 to deploy a VM. The VM name 2402 shows the name of a VM to deploy. The number of CPU 2403 shows the number of CPU of a VM to deploy. The memory capacity 2404 shows the capacity of memory of a. VM to deploy. The volume name 2405 shows the volume name that a VM uses.

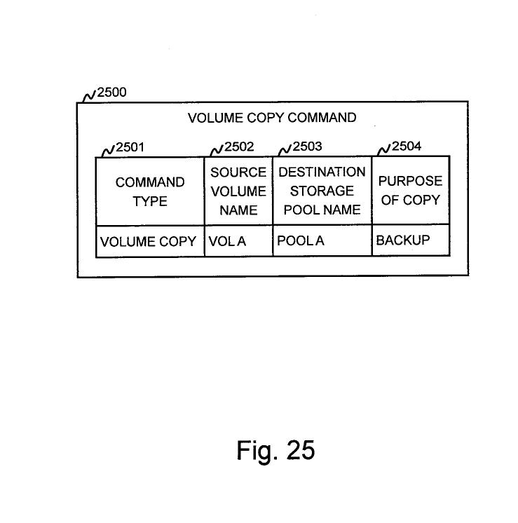

FIG. 25 shows an example of a volume copy command 2500 according to the first embodiment. The volume copy command 2500 includes a command type 2501, a source volume name 2502, a destination storage pool name 2503, and a purpose of copy 2504. The management server 380 sends the volume copy command 2500 to the storage subsystem 360 to deploy a volume. When the storage subsystem 360 receives the volume copy command 2500, the storage subsystem 360 creates a volume in the storage pool specified by the destination storage pool name 2503 and copies the volume specified by the source volume name 2502 to the volume that the storage subsystem 360 created. The purpose of copy 2504 shows the purpose to copy a volume.

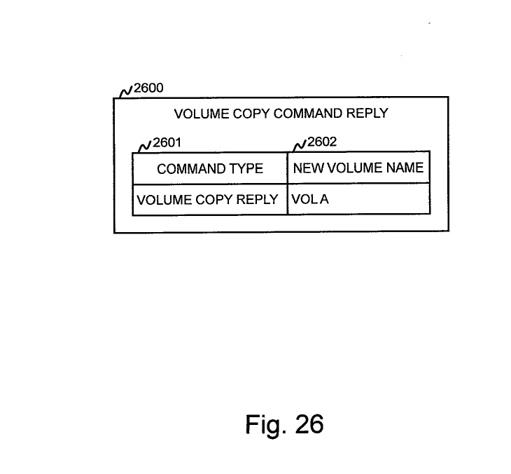

FIG. 26 shows an example of a volume copy command reply 2600. The volume copy command reply 2600 includes a command type 2601 and a new volume name 2602. The storage subsystem 360 sends the volume copy command reply 2600 to the management server 380. The new volume name 2602 shows the volume to which the volume specified by the source volume name 2602 is copied.

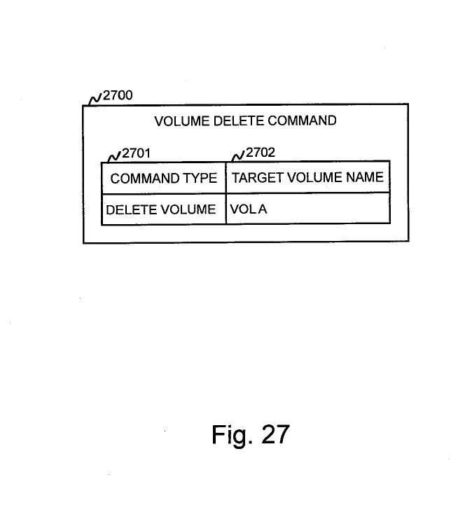

FIG. 27 shows an example of a volume delete command 2700. The volume delete command 2700 includes a command type 2701 and a target volume name 2702. The management server 380 sends the volume delete command 2700 to the storage subsystem 360 to delete a volume specified by the target volume name 2702.

B. Process Flows

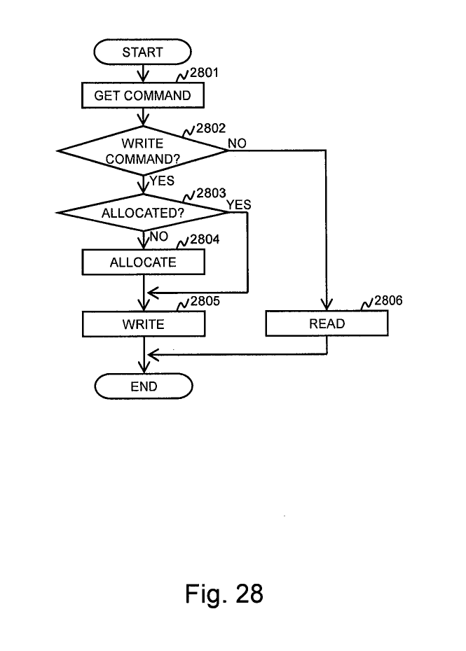

FIG. 28 is an example of a flow diagram showing that the VHD control program 402 receives the VHD read command 2000 or the VHD write command 2100 from the application program 408, sends the read command 2200 or the write command 2300 to the storage subsystem 360, and sends the result of read or write to the application program 408. In step 2801, the VHD control program 402 receives the VHD read command 2000 or the VHD write command 2100 from the application program 408. In decision step 2802, if the command that the VHD control program 402 received in step 2801 is the VHD write command 2100, then the process goes to decision step 2803; if not, then the process goes to step 2806. In decision step 2803, if the area specified by the volume address 2103 in the VHD write command 2100 is allocated in the VHD address 702 in the VHD location information 403, and then the process goes to step 2805; if not, then the process goes to step 2804. In step 2804, the VHD control program 402 searches unallocated area to any VHDs from the VHD location information 403 and updates the VHD location information 403. In step 2805, the VHD control program 402 calculates the volume name 2302 and the volume address 2303 from the VHD name 2102, the VHD address 2103, and the VHD location information 403, sends the write command 2300 to the storage subsystem 360, and sends the result of write from the storage subsystem 360 to the application program 408. In step 2806, the VHD control program 402 calculates the volume name 2202 and the volume address 2203 from the VHD name 2002, the VHD address 2003, and the VHD location information 403, sends the read command 2200 to the storage subsystem 360, and sends the result of read from the storage subsystem 360 to the application program 408.

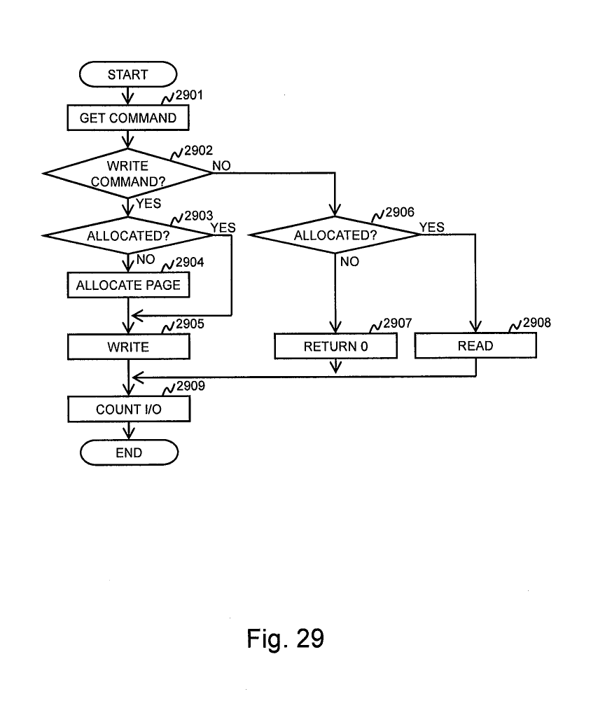

FIG. 29 is an example of a flow diagram showing that the disk control program 501 receives the read command 2200 or the write command 2300 from the VHD control program 402, and the disk control program 501 sends the result of read or write to the VHD control program 402. In step 2901, the disk control program 501 receives the read command 2200 or the write command 2300 from the VHD control program 402. In decision step 2902, if the command that the disk control program 501 received in step 2901 is the write command 2300, then the process goes to decision step 2903; if not, then the process goes to decision step 2906. In decision step 2903, if an area specified by the volume name 2302 and the volume address 2303 of the write command 2300 is allocated in the virtual volume information 505, then the process goes to step 2905; if not, then the process goes to step 2904. In step 2904, the disk control program 501 allocates an unallocated area of a logical volume for which the media type is specified by the default tier 1503 in the tier definition information 507 to the area specified by the volume name 2302 and the volume address 2303, and updates the virtual volume information 505. If the tier policy 1402 of the volume specified by the volume name 2302 is not “AUTO”, then the disk control program 501 updates the pinned 1308 of the page specified by the volume address 2303 to “X.” In step 2905, the disk control program 501 gets the volume name 2302 and the volume address 2303 from the write command 2300, gets the logical volume name 1305 and the logical volume address 1306 from the virtual volume information 505, gets the RAID group name 1003 and the RAID group address 1004 from the logical volume information 503, and writes the data 2304 in the write command 2300 to the area specified by the RAID group name 1103 and the RAID group address 1104. In decision step 2906, if an area specified by the volume name 2202 and the volume address 2203 of the read command 2200 is allocated in the virtual volume information 505, then the process goes to step 2908; if not, then the process goes to step 2907. In step 2907, the disk control program 501 returns “0” to the application server 300 because the area specified by the volume name 2202 and the volume address 2203 is not written. In step 2908, the disk control program 501 gets the volume name 2202 and the volume address 2203 from the read command 2200, gets the logical volume name 1305 and the logical volume address 1306 from the virtual volume information 505, gets the RAID group name 1103 and the RAID group address 1104 from the logical volume information 503, reads the area specified by the RAID group name 1103 and the RAID group address 1104, and returns the data. In step 2909, if the command that the disk control program 501 received in step 2901 is the write command 2300, then the disk control program 501 increments the number of accesses 1306 of the row specified by the volume name 2302 and the volume address 2303 in the write command 2300 by “1,” if not, then the disk control program 501 increments the number of access 1306 of the row specified by the volume name 2202 and the volume address 2203 in the read command 2200 by “1.”

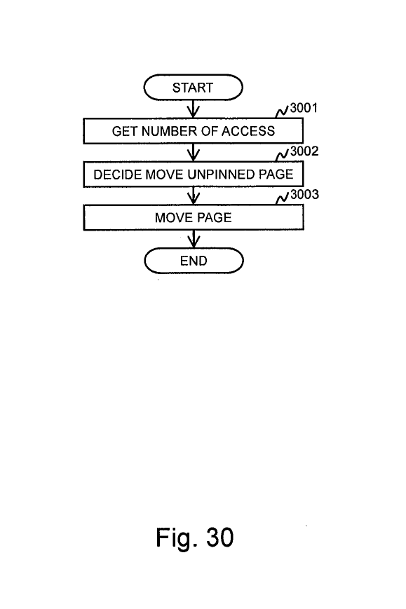

FIG. 30 is an example of a flow diagram showing the process by which the page move program 508 moves pages. The page move program 508 regularly moves frequently accessed pages to a higher tier and rarely accessed pages to a lower tier. In this embodiment, as defined in the tier definition information 507, there are three tiers, where tier 1 is the highest tier and tier 3 is the lowest tier. In step 3001, the page move program 508 gets the number of accesses 1307 from the virtual volume information 505. In step 3002, the page move program 508 calculates the capacity in each tier based on the RAID group information 502, the logical volume information 503, and the storage pool information 504, assign pages in decreasing order to tiers in decreasing order except pages for which the pinned 1308 is checked, and decides pages that should be moved to another tier. In step 3003, the page move program 508 moves the pages that are decided to be moved in step 3002 to the tier specified in step 3002 and updates the virtual volume information 505.

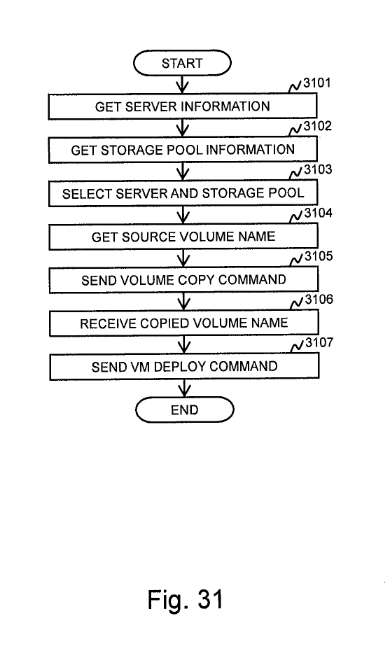

FIG. 31 is an example of a flow diagram showing the process by which the VM deploy program 602 deploys a VM when an administrator inputs information about the VM with the VM deploy screen 607 and pushes the OK button 1808. In step 3101, the VM deploy program 602 gets the server information 404 from the one or more application servers 300. In step 3102, the VM deploy program 602 gets the storage pool information 504 from the one or more storage subsystems 360. The VM deploy program 602 selects an application server that has CPUs of the number specified by the number of CPU 1803 and selects a memory of the amount specified by the memory 1804 based on the server information 404, and selects a storage pool that has an amount specified by the storage capacity 1805 and selects a copy or snapshot function based on the storage pool information 504. In step 3104, the VM deploy program 602 gets the volume name 1603 of the row in which the entry in the template name column 1601 is the template name 1802. In step 3105, the VM deploy program 602 sends the volume copy command 2500 for which the entry in the source volume name column 2502 is the volume name obtained in step 3104, the entry in the destination storage pool name column 2503 is the storage pool name selected in step 3103, and the entry in the purpose of copy column 2504 is “DEPLOY” to the storage subsystem 360. In step 3106, the VM deploy program 602 receives the volume copy command reply 2600 from the storage subsystem 360. In step 3107, the VM deploy program 602 sends the VM deploy command 2400 for which the entry in the VM name column 2402 is the VM name 1801, the entry in the number of CPU column 2403 is the number of CPU 1803, the entry in the memory capacity column 2404 is the memory 1804, and the entry in the volume name column 2405 is the volume name received in step 3106 to the application server 300.

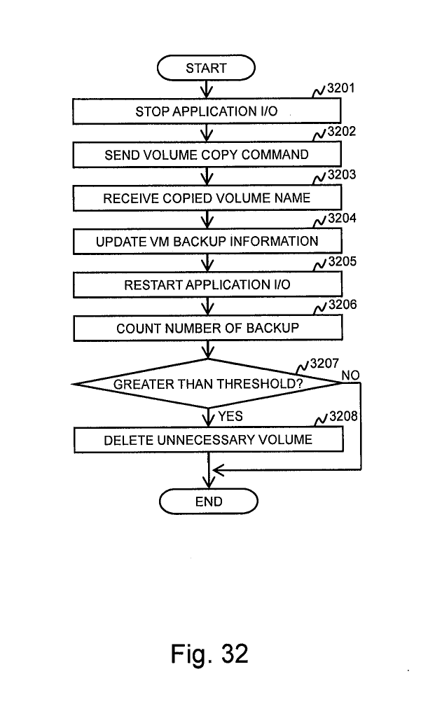

FIG. 32 is an example of a flow diagram showing the process by which the VM backup program 603 backs up a VM regularly every backup cycle based on the backup cycle 907 of the VM. In step 3201, the backup program 603 stops I/O (Input and Output) of the application program 408 running on the VM 406. In step 3202, the backup program 603 sends the volume copy command 2500 for which the entry in the source volume name column 2502 is the volume name 905, the entry in the destination storage pool name column 2503 is the storage pool name that has free space enough to copy the volume, and the entry in the purpose of copy column 2504 is “BACKUP” to the storage subsystem 360. In step 3203, the backup program 603 receives the volume copy command reply 2600 from the storage subsystem 360. In step 3204, the VM backup program 603 updates the VM backup information 606 based on the VM name, the volume name received in step 3203, and the date and time. In step 3205, the backup program 603 restarts I/O of the application program 408. In step 3206, the backup program 603 counts the number of backups based on the VM backup information 606. For example, there are three backups of “VM A.” In decision step 3207, if the number of backups counted in step 3206 is greater than the number of generation 908, then the process goes to step 3208; if not, then the process ends. In step 3208, the VM backup program 3208 selects the oldest volume that should be deleted and sends to the storage subsystem 360 the volume delete command 2700 specifying the target volume name 2502 is the volume of the VM selected in step 3208.

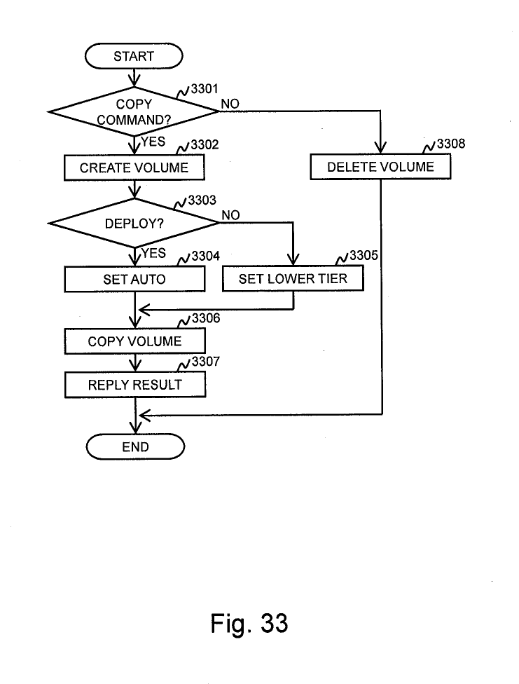

FIG. 33 is an example of a flow diagram showing the process to be performed when the volume configuration program 509 receives the volume copy command 2500 or the volume delete command 2700 according to the first embodiment. In decision step 3301, if the volume configuration program 509 receives the volume copy command 2500, then the process goes to step 3302; if not, then the process goes to step 3308. In step 3302, the volume configuration program 509 generates a unique name for a new volume, creates the volume on the storage pool specified by the destination storage pool name 2503, and updates the virtual volume information 505. In decision step 3303, if the purpose of copy 2504 is “DEPLOY”, then the process goes to step 3304; if not, the process goes to step 3305. In step 3304, the volume configuration program 509 adds to the virtual volume tier policy information 506 a row in which the volume name 1401 is the name generated in step 3302 and the tier policy 1402 is “AUTO.” In step 3305, the volume configuration program 509 adds to the virtual volume tier policy information 506 a row in which the volume name 1401 is the name generated in step 3302 and the tier policy 1402 is “TIER 3.” In step 3306, the volume configuration program 509 copies the volume specified by the source volume name 2502 to the volume created in step 3302. In step 3307, the volume configuration program 509 sends the volume copy command reply 2600 for which the new volume name 2602 is the volume name generated in 3302 to the management server 380. In step 3308, the volume configuration program 509 deletes the volume specified by the target volume name 2702 and updates the virtual volume information 505 and the virtual volume tier policy information 506.

### Second Embodiment

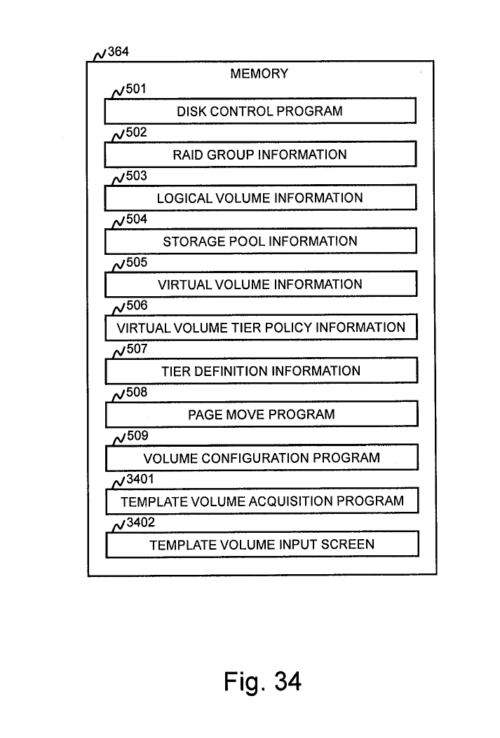

FIG. 34 illustrates an example of the memory 364 in the storage subsystem 360 of FIG. 3 according to the second embodiment. The memory 364 comprises the disk control program 501, the RAID group information 502, the logical volume information 503, the storage pool information 504, the virtual volume information 505, the virtual volume tier policy information 506, the tier definition information 507, the page move program 508, the volume configuration program 509, a template volume acquisition program 3401, and a template volume input screen 3402.

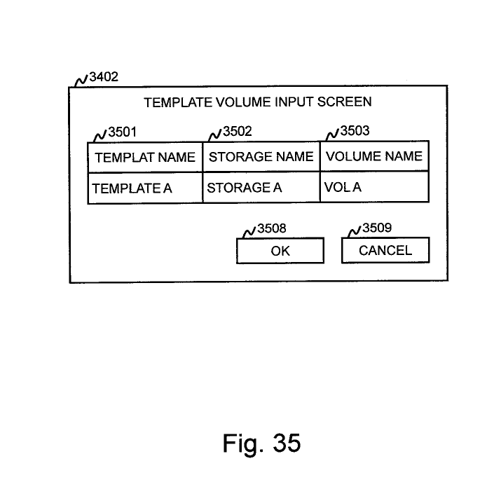

FIG. 35 shows an example of the template volume input screen 3402 according to the second embodiment. The template volume input screen 3402 includes a template name 3501, a storage name 3502, and a volume name 3503. An administrator inputs information about template volume using the template volume input screen 3402. The template name 3501 shows a name of a VM template. The storage name 3502 shows the storage subsystem that has a volume that stores the VM template. The volume name 3503 shows the volume that stores the VM template.

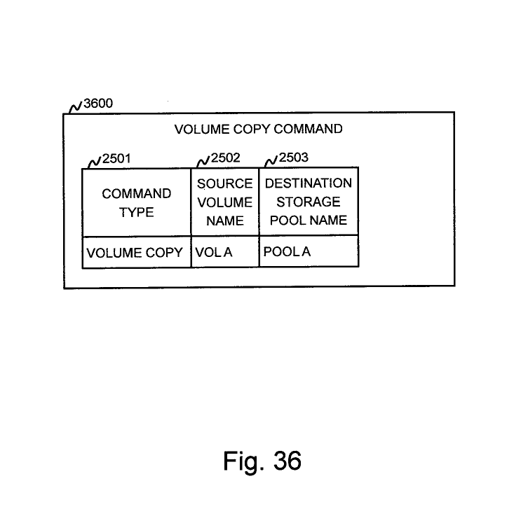

FIG. 36 shows an example of a volume copy command 3600 according to the second embodiment. The volume copy command 3600 is the same as the volume command 2500 in FIG. 25 except the volume copy command 3600 does not have the purpose of copy 2504.

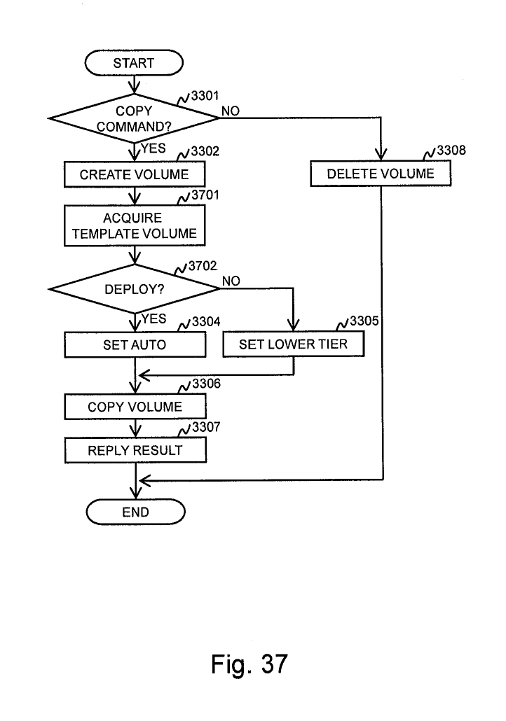

FIG. 37 is an example of a flow diagram showing the process to be performed when the volume configuration program 509 receives the volume copy command 2500 or the volume delete command 2700 according to the second embodiment. FIG. 37 is similar to FIG. 33 (first embodiment). Steps 3301, 3302, 3304, 3305, 3306, 3307, and 3308 are similar to those of FIG. 33. Instead of step 3303, however, FIG. 37 has steps 3701 and 3702. In step 3701, the template volume acquisition program 3401 gets information about template volumes from the VM template information 605 in the management server 380 or the template volume input screen 3402 input by an administrator. In decision step 3302, if the source volume name 2502 is same as the volume acquired in step 3701, then the process goes to 3304 because the purpose of this copy is to deploy; if not, then the process goes to step 3305.

Of course, the system configuration illustrated in FIG. 3 is purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for tier management to deploy and backup volumes. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A storage system comprising:
a plurality of storage devices providing a plurality of logical volumes, the plurality of storage devices being divided into a plurality of types of tiers having different performance levels; and
a controller operable to control to store data to a logical volume of the plurality of logical volumes provided by the storage devices;
wherein the controller is configured to receive a command commanding to copy data to deploy a template to a logical volume of the plurality of logical volumes or to back up data to a logical volume of the plurality of logical volumes;
wherein in response to the command received by the controller, the controller is configured to allocate a storage area of a tier of the plurality of types of tiers to the logical volume; and
wherein the tier of the storage area to allocate to the logical volume is determined based on whether the command received by the controller is to copy data to the template to the logical volume or to back up data to the logical volume.

2. The storage system according to claim 1,
wherein the tier of the storage area to allocate to the logical volume for copying data to deploy the template to the logical volume is a higher performance tier than the tier of the storage area to allocate to the logical volume for backing up data to the logical volume.

3. The storage system according to claim 1,
wherein the tier of the storage area to allocate to the logical volume for backing up data to the logical volume is a lowest tier of all the tiers; and
wherein the tier of the storage area to allocate to the logical volume for copying data to deploy the template to the logical volume is determined based on a number of access to pages of the logical volume, the tier for a larger number of access being a same performance tier as or a higher performance tier than the tier for a lower number of access.

4. The storage system according to claim 1,
wherein the command includes information specifying whether the command is to copy data to the template to the logical volume or to back up data to the logical volume.

5. The storage system according to claim 1,
wherein the command includes information on a source storage volume from which to copy data to the logical volume and includes no information specifying whether the command is to copy data to the template to the logical volume or to back up data to the logical volume;
wherein the controller is configured to obtain template information specifying a storage device and a storage volume in the storage device for storing the template; and
wherein if the source storage volume is same as the storage volume for storing the template, then the command is to copy data to the template.

6. The storage system according to claim 5,
wherein the template information is obtained from a management computer or from a template volume input by an administrator.

7. The storage system according to claim 1,
wherein the template is a virtual machine template.

8. A method of storing data to a logical volume of a plurality of logical volumes provided by a plurality of storage devices which are divided into a plurality of types of tiers having different performance levels in a storage system, in response to a command received by a controller of the storage system, commanding to copy data to a template to a logical volume of the plurality of logical volumes or to back up data to a logical volume of the plurality of logical volumes, the method comprising:
determining, by the controller, a tier of a storage area to allocate to the logical volume based on whether the command is to copy data to the template to the logical volume or to back up data to the logical volume; and
allocating to the logical volume, by the controller, the storage area of the determined tier of the plurality of types of tiers.

9. The method according to claim 8,
wherein the tier of the storage area to allocate to the logical volume for copying data to deploy the template to the logical volume is a higher performance tier than the tier of the storage area to allocate to the logical volume for backing up data to the logical volume.

10. The method according to claim 8,
wherein the tier of the storage area to allocate to the logical volume for backing up data to the logical volume is a lowest tier of all the tiers; and
wherein the tier of the storage area to allocate to the logical volume for copying data to deploy the template to the logical volume is determined based on a number of access to pages of the logical volume, the tier for a larger number of access being a same performance tier as or a higher performance tier than the tier for a lower number of access.

11. The method according to claim 8,
wherein the command includes information specifying whether the command is to copy data to the template to the logical volume or to back up data to the logical volume.

12. The method according to claim 8,
wherein the command includes information on a source storage volume from which to copy data to the logical volume and includes no information specifying whether the command is to copy data to the template to the logical volume or to back up data to the logical volume;
wherein the method further comprises obtaining, by the controller, template information specifying a storage device and a storage volume in the storage device for storing the template; and
wherein if the source storage volume is same as the storage volume for storing the template, then the command is to copy data to the template.

13. The method according to claim 12,
wherein the template information is obtained from a management computer or from a template volume input by an administrator.

14. The method according to claim 8,
wherein the template is a virtual machine template.

15. A computer-readable storage medium storing a plurality of instructions for controlling a data processor to store data to a logical volume of a plurality of logical volumes provided by a plurality of storage devices which are divided into a plurality of types of tiers having different performance levels in a storage system, in response to a command received by a controller of the storage system, commanding to copy data to a template to a logical volume of the plurality of logical volumes or to back up data to a logical volume of the plurality of logical volumes, the plurality of instructions comprising:
instructions that cause the data processor to determine a tier of a storage area to allocate to the logical volume based on whether the command is to copy data to the template to the logical volume or to back up data to the logical volume; and
instructions that cause the data processor to allocate to the logical volume the storage area of the determined tier of the plurality of types of tiers.

16. The computer-readable storage medium according to claim 15,
wherein the tier of the storage area to allocate to the logical volume for copying data to deploy the template to the logical volume is a higher performance tier than the tier of the storage area to allocate to the logical volume for backing up data to the logical volume.

17. The computer-readable storage medium according to claim 15,
wherein the tier of the storage area to allocate to the logical volume for backing up data to the logical volume is a lowest tier of all the tiers; and
wherein the tier of the storage area to allocate to the logical volume for copying data to deploy the template to the logical volume is determined based on a number of access to pages of the logical volume, the tier for a larger number of access being a same performance tier as or a higher performance tier than the tier for a lower number of access.

18. The computer-readable storage medium according to claim 15,
wherein the command includes information specifying whether the command is to copy data to the template to the logical volume or to back up data to the logical volume.

19. The computer-readable storage medium according to claim 15,
wherein the command includes information on a source storage volume from which to copy data to the logical volume and includes no information specifying whether the command is to copy data to the template to the logical volume or to back up data to the logical volume;
wherein the plurality of instructions further comprise instructions that cause the data processor to obtain template information specifying a storage device and a storage volume in the storage device for storing the template; and
wherein if the source storage volume is same as the storage volume for storing the template, then the command is to copy data to the template.

20. The computer-readable storage medium according to claim 19,
wherein the template information is obtained from a management computer or from a template volume input by an administrator.
